(19) United States
(12) Patent Application Publication
(10) Pub. No.: US 2012/0254822 A1
(43) Pub. Date: Oct. 4, 2012

(54) PROCESSING OPTIMIZATION LOAD ADJUSTMENT

(75) Inventors: Zheng Lin, Issaquah, WA (US); Akan A. Usoro, Renton, WA (US); Jonathan M. Class, Snohomish, WA (US)

(73) Assignee: Microsoft Corporation, Redmond, WA (US)

(21) Appl. No.: 13/073,626

(22) Filed: Mar. 28, 2011

(51) Int. Cl. G06F 9/44

(52) U.S. Cl. 717/101

(57) ABSTRACT

In embodiments of processing optimization load adjustment, work units of a software build project are processed, and the processing generally maximizes utilization of the processing resources of a computing device. Performance data of the processing resources is collected as the work units of the software build project are processed. A determination is made as to whether utilization of the processing resources is optimal to process the software build project while avoiding adverse resource conditions. The number of the work units that are processing can then be increased in response to determining that utilization of the processing resources is not optimal. Alternatively, the number of the work units that are processing can be decreased in response to determining that utilization of the processing resources exceeds optimal processing. Alternatively, the work units that are processing can be allowed to complete processing without scheduling additional work units for processing.

### BACKGROUND

Large-scale software development projects are extensive, and many developers, working independently, author source code that is later compiled to develop a software application, such as an operating system or browser application. The build process for an extensive software build project is also system resource intensive, and a dedicated machine may run several hours to build the software project each time that it's compiled. The use of static values to control machine resource utilization on the computing device typically requires user intervention and may not apply to all of the hardware configurations of different computing devices, which results in sub-optimal build performance. Some conventional techniques operate based on a static thread pool that is defined prior to build invocation of a software build project. However, these techniques are also not able to respond to changing machine resource conditions and utilization.

### SUMMARY

This Summary introduces simplified concepts of processing optimization load adjustment, and the concepts are further described below in the Detailed Description and/or shown in the Figures. This Summary should not be considered to describe essential features of the claimed subject matter, nor used to determine or limit the scope of the claimed subject matter.

Processing optimization load adjustment is described. In embodiments, work units of a software build project are processed, and processing the work units generally maximizes utilization of the processing resources of a computing device. In implementations, the processing resources of a computing device include one or more processors (CPUs), random access memory (RAM), and a disk input/output (disk I/O) latency threshold. Performance data of the processing resources can be collected as the work units of the software build project are processed.

A determination can be made as to whether utilization of the processing resources is optimal to process the software build project while avoiding adverse resource conditions. The number of the work units that are processing can then be increased in response to a determination that utilization of the processing resources is not optimal. Alternatively, the number of the work units that are processing can be decreased in response to a determination that utilization of the processing resources exceeds optimal processing. Alternatively, the work units that are processing can be allowed to complete processing without scheduling additional work units for processing.

In other embodiments, the performance data of the processing resources indicates a percentage of CPU utilization, a percentage of available RAM, and disk I/O latency. The performance data for a processing resource may be an average of the performance data and collected in real-time intervals. Additionally, each work unit of the software build project invokes different levels of processing resources utilization. Parameters of the processing resources can be definable as a basis for determining whether the utilization of the processing resources is optimal.

In other embodiments, tasks for one or more additional device applications can be executed on the computing device that processes the work units of the software build project. The collected performance data then indicates utilization of the processing resources to process the tasks for the additional device applications as well as the work units of the software build project. The determination as to whether utilization of the processing resources is optimal to process the software build project can also include avoiding interruption of processing the tasks for the additional device applications.

### BRIEF DESCRIPTION OF THE DRAWINGS

Embodiments of processing optimization load adjustment are described with reference to the following Figures. The same numbers may be used throughout to reference like features and components that are shown in the Figures:

FIG. 1 illustrates an example computing device in which embodiments of processing optimization load adjustment can be implemented.

FIG. 2 illustrates an example chart of processing resources utilization over time in accordance with one or more embodiments.

FIG. 3 illustrates example method(s) of processing optimization load adjustment in accordance with one or more embodiments.

FIG. 4 illustrates another example computing device in accordance with one or more embodiments.

FIG. 5 illustrates another example chart of processing resources utilization over time in accordance with one or more embodiments.

FIG. 6 illustrates example method(s) of processing optimization load adjustment in accordance with one or more embodiments.

FIG. 7 illustrates various components of an example device that can implement embodiments of processing optimization load adjustment.

### DETAILED DESCRIPTION

Processing optimization load adjustment is described, and embodiments can be implemented for build engine load throttling, such as to optimize the processing resources to build or compile a software build project. The processing resources of a computing device, such as one or more processors (CPUs), random access memory (RAM), and disk input/output (disk I/O) latency can be monitored to determine whether utilization of the processing resources is optimal. The processing resources are monitored in real-time to determine whether the computing device is capable of increased processing while instruction work units of the software build project and/or application task instructions of additional device applications are processed.

If the processing workload is not maximized, additional instruction work units of the software build project can be scheduled for processing to increase the processing workload. If utilization of the processing resources exceeds optimal processing, then the instruction work units of the software build project can be suspended to decrease the processing workload. Alternatively, the instruction work units of the software build project that are currently processing can be allowed to complete processing without increasing or decreasing the processing workload.

While features and concepts of processing optimization load adjustment can be implemented in any number of different devices, systems, environments, networks, and/or configurations, embodiments of processing optimization load adjustment are described in the context of the following example devices, systems, and methods.

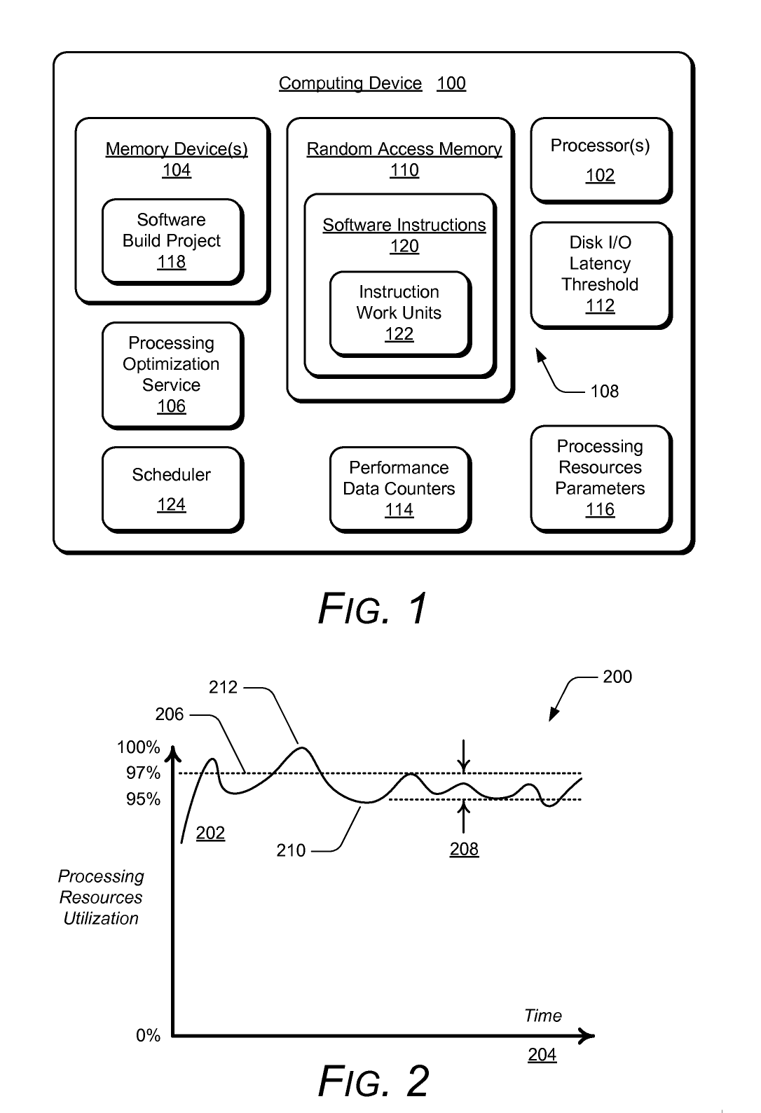

FIG. 1 illustrates an example computing device 100 in which embodiments of processing optimization load adjustment can be implemented. The example computing device may be any type of a computer, server, dedicated machine, state machine, and the like. The computing device can be implemented with various components, such as one or more processors 102 (CPUs) and memory devices 104 (e.g., computer-readable storage media) that enable data storage. The computing device may also include any number and combination of differing components as further described with reference to the example device shown in FIG. 7. The processors and memory of the computing device implement a processing optimization service 106 as computer-executable instructions, such as a software application, that is executable to implement the various embodiments of processing optimization load adjustment described herein.

The computing device 100 includes processing resources 108, such as the one or more processors 102 (CPUs), random access memory (RAM) 110, and a disk input/output (I/O) latency threshold 112. Alternatively or in addition, the monitored processing resources of a computing device may include network bandwidth, or generally, any resource based on a predefined metric to determine optimal resource utilization. The RAM referred to herein as a processing resource is a logical construct, which extends to non-physical-RAM storage, such as when data is paged out of RAM and written to disk. When information is paged out of RAM, the software instructions may be written to disk. Performance data counters 114 maintain performance data of the processing resources as tasks and instructions of software applications and/or projects are executed. The performance data that corresponds to the processing resources indicates a percentage of CPU utilization, a percentage of available RAM, and disk I/O latency.

In embodiments, the computing device 100 includes processing resources parameters 116, and the parameters of the processing resources 108 are definable for comparison to determine whether utilization of the processing resources is optimal. A user of the computing device can configure the system for optimal resource utilization. In an implementation example, the processing resources can be represented as in the following table, according to set threshold defaults that initiate the processing optimization service 106 for processing optimization load adjustment:

| | System Defaults | | | Optimal Utilization | |
|---|---|---|---|---|---|
| | Min | Max | | Min | Max |
| CPU | 0% | 100% | | <97% | >99% |
| Available Memory | 0 GB | Total Memory | | 2% | 4% |
| Disk I/O Latency | N/A | 100 | ms | N/A | >100 ms |
| Periodic Data | 1 CPU | 5 | seconds | *Note | |
| Collection | Instruction | | | | |

*Note:
The periodic interval over which the data is collected and analyzed is flexible, and optionally, user-configurable. For example, the system default for periodic data collection may be implemented as one-second, within the range from one CPU instruction to five-seconds, as indicated in the table (e.g., this is a large range from the small value of one CPU instruction to the large value of five-seconds).

The processing optimization service 106 is implemented to collect the performance data in real-time intervals from the performance data counters 114. Values of the performance data can be obtained from implementations of system performance monitoring. The processor time, available memory, and disk I/O counters can be monitored and sampled on a periodic interval. The values of the performance data can also be determined based on a running average of the stored performance data readings. The performance data collected at the periodic interval is an atomic data cycle for the particular resources being measured. In implementations, the performance data is measured as an average between the present and previously sampled value. A data cycle can be utilized to smooth out spikes in measured values that could occur at short intervals, such as for CPU utilization. In an example implementation, a minimum of two data readings per cycle may be implemented.

The computing device 100 can be utilized to build or execute a software build project 118, such as a large-scale software development build project that maximizes utilization of the processing resources 108 of the computing device. The RAM 110 loads and maintains software instructions 120 (e.g., to include instructions that have been written to and/or retrieved from non-physical-RAM storage) of the software build project, and instruction work units 122 of the software build project are processed with the processing resources. Each of the instruction work units 122 may utilize a different amount of CPU, RAM, and/or affect disk I/O latency when the software instructions 120 are processed. In implementations, the computing device may be a dedicated machine that runs several hours to build the software build project, which is time-dependent and ideally completed as quickly and as efficiently as possible.

In embodiments, the processing optimization service 106 is implemented to determine whether utilization of the processing resources 108 is optimal to process the software build project 118 (e.g., the instruction work units 122 of the software build project) and avoid adverse resource conditions of the processing resources. The utilization of the processing resources can be determined by comparison with the defined resources threshold values as described above. Utilization of the processing resources may be adverse to optimal processing, or exceed optimal processing (e.g. when low resource conditions are encountered, such as excessive context switches, out of memory, excessive paging, disk thrashing, etc).

The computing device 100 also includes a scheduler 124. In embodiments, the scheduler may include the processing optimization service 106 as an integrated component or service of the scheduler. Alternatively, the software build project 118 may be implemented to include the processing optimization service as an integrated component or service of the project. The scheduler is implemented to schedule the processing of additional work units of the software build project to increase the number of instruction work units 122 that are processing if the processing optimization service determines that utilization of the processing resources 108 is not optimal. If the processing optimization service determines that utilization of the processing resources exceeds optimal processing, the scheduler is also implemented to either decrease the number of instruction work units that are processing, or allow the current instruction work units to complete processing.

A workload adjustment for utilization of the processing resources 108 can be accomplished by increasing and/or decreasing the number of instruction work units 122 that are scheduled and pending during processing to build the software build project 118. Initially on startup of the computing device 100, a value of workload adjustment corresponds to the number of processing threads that are available to a build application to schedule the instruction work units to the thread pool. In an implementation, the maximum number of processing threads can be set at three times the number of processors 102 and the minimum number of processing threads can initially correspond to the number of processors. The processing optimization service 106 initiates an increase in the number of processing threads as needed to reach steady state or optimal utilization of the processing resources, whichever is obtained first.

In relation to the number of processing threads, the number of pending instruction work units 122 can equal, but not exceed, the maximum number of processing threads. However, on the lower bound, the pending instruction work units can be decreased below the set minimum number of processing threads. This accommodates a decreasing workload adjustment in the event that utilization of the processing resources 108 is constrained by low available RAM 110 or unusually high disk I/O latency (e.g., as determined when compared to the disk I/O latency threshold 112). In embodiments, the processing resources 108 can be prioritized based on the effect of utilization. For example, the available system RAM is prioritized first, then disk I/O latency is prioritized second, and CPU utilization is prioritized third when considering optimal utilization of the processing resources.

If the available system RAM 110 is less than a set upper bound, then CPU-based throttling can be reset to a default value and/or disabled until the available system RAM recovers and more than the set upper bound is available. If utilization of the processing resources is constrained by available system RAM, such as when the available RAM is less than or equal to the set lower bound, the scheduler 124 can pause momentarily to allow the current instruction work units 122 to complete processing and allow the available RAM to increase. In an implementation, the default value of stored data readings per cycle can be set to a value of four, since memory consumption is more gradual as available RAM decreases. Scheduling and/or CPU throttling, and effectively disk I/O throttling, can be resumed when a level of available RAM has increased above the upper bound level.

The workload adjustment may be a utilization decrease of the processing resources 108 if the disk I/O latency exceeds the disk I/O latency threshold 112. In an example implementation, the average disk I/O latency for a disk read or write operation may be a few milliseconds in a particular system. Latency time increases as the rate of disk I/O increases and a latency that then increases to several milliseconds for a sustained duration can cause the processing performance to degrade. The value of disk I/O latency can vary between systems with different hard disk configurations. In an implementation, the disk I/O latency threshold is 100 ms, and four is the default number of stored data readings per cycle. The computing device 100 may include more than one physical disk, in which case all of the disks can be monitored for disk I/O latency, and a determination of any one of the disks exceeding the disk I/O latency threshold 112 can initiate throttling utilization of the processing resources.

The workload adjustment may be a utilization increase of the processing resources 108 if CPU utilization is less than a set minimum threshold and if there are additional instruction work units 122 to process. Alternatively, the workload adjustment can be a utilization decrease if CPU utilization exceeds a set maximum threshold. Utilization of the processing resources can be set to a default when there are no instruction work units 122 in the work unit queues to process. If the available RAM 110 is less than the set upper bound, CPU throttling can be set to the default value and the functionality is disabled. In an implementation, the default number of stored data readings per cycles is set to four-plus (4+).

With reference to the defaults and parameter overrides, the number of processing threads per pass value is statically set during a time build run, and for an individual invocation of the build application, the number of processing threads can be statically configured (e.g. set to the same number of available processors 102, thus providing one thread per processor) unless overridden. In an implementation, the initial workload value for the number of processing threads to the number of pending instruction work units 122 can be set to the number of system processors. In general, however, system defaults can be overridden with user-defined values. The computing device can run in a multiprocessor mode with the processing optimization service 106 in control of automatically initiating the workload adjustments for optimal utilization of the processing resources 108.

In implementations, options may be provided to override the resources throttling defaults. The following table indicates example implementation parameters, of which any may be optionally configurable, and that may be selected to define an increase and/or decrease of the workload adjustment for utilization of the processing resources:

| Name | Defaults |
|---|---|
| BUILD_CPU_WORKLOAD_ADJUSTMENT | 4 |
| BUILD_MEM_WORKLOAD_ADJUSTMENT | 1 |
| BUILD_DISKIO_WORKLOAD_ADJUSTMENT | 2 |
| Periodic Data Collection Interval | 1 second |

The following table indicates example processing resources threshold parameters and default values that may be implemented in embodiments of processing optimization load adjustment:

| Name | Default Value | Description |
|---|---|---|
| BUILD_MAX_CPU_THRESHOLD | 99% | Decrease workload if higher |
| BUILD_MIN_CPU_THRESHOLD | 97% | Increase workload if lower |
| BUILD_MEM_UPPER_LIMIT | 4% | Disable CPU/Disk I/O throttling; |
| | | reset to default workload |
| BUILD_MEM_LOWER_LIMIT | 2% | Pause workload until recover |
| BUILD_DISKIO_LATENCY_THRESHOLD | 100 ms | Decrease workload if higher |

The following table indicates example parameters, of which any may be optionally configurable, to adjust threshold sensitivity (i.e., adjust the number of data readings per cycle), and that may be implemented in embodiments of processing optimization load adjustment:

| Name | Defaults |
|---|---|
| BUILD_CPU_THRESHOLD_SENSITVITY | 4 |
| BUILD_MEM_THRESHOLD_SENSITIVITY | 2 |
| BUILD_DISKIO_THRESHOLD_SENSITIVITY | 4 |
| Periodic Data Collection Interval | 1 second |

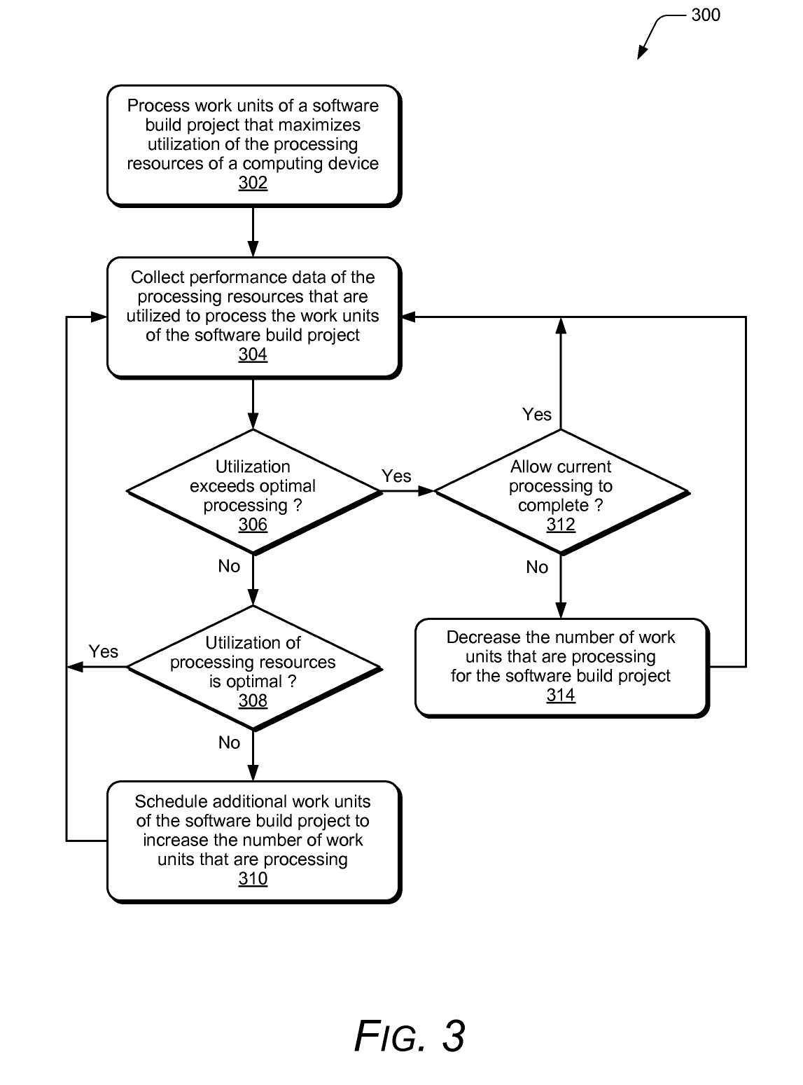

FIG. 2 illustrates an example chart 200 of processing resources utilization 202 over time 204 in accordance with the embodiments of processing optimization load adjustment described herein. In this example, an optimization 206 of the processing resources 108 in a computing device 100 (FIG. 1) is implemented as approximately 97% utilization of the processing resources. The optimization of the processing resources may also be defined or implemented as a range 208 of utilization, such as from approximately 95% to 97% in this example.

As described above with reference to the computing device 100 shown in FIG. 1, the processing optimization service 106 is implemented to determine whether utilization of the processing resources 108 is optimal to process the software build project 118 (e.g., the instruction work units 122 of the software build project) and avoid adverse resource conditions of the processing resources. For example, when the utilization 202 of the processing resources 108 is less than optimal at 210, the scheduler 124 is implemented to schedule the processing of additional work units of the software build project to increase the number of instruction work units that are processing. Alternatively, when the processing optimization service determines that utilization 202 of the processing resources 108 exceeds optimal processing at 212, the scheduler is implemented to either decrease the number of instruction work units that are processing, or allow the current instruction work units to complete processing.

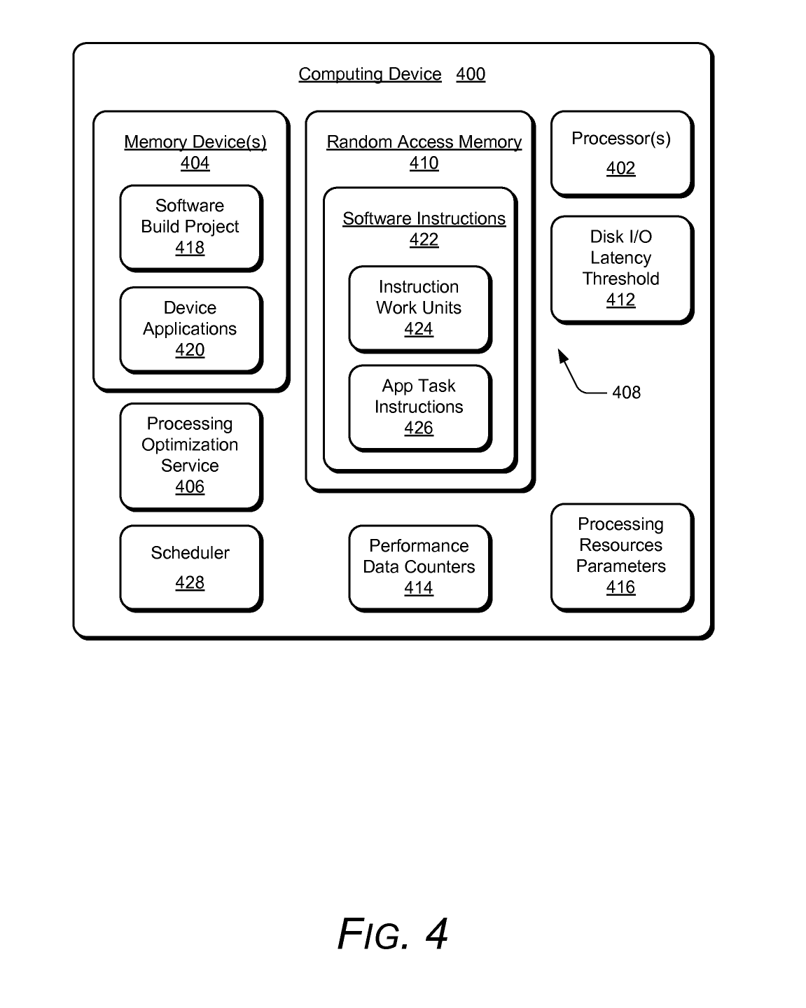

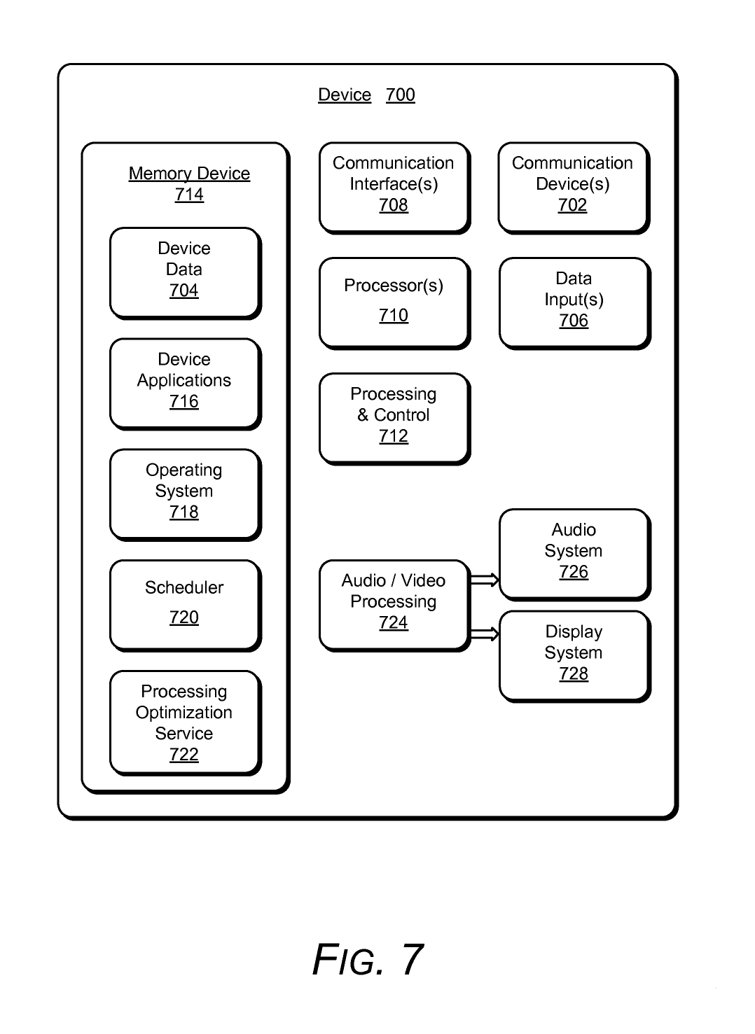

Example methods 300 and 600 are described with reference to respective FIGS. 3 and 6 in accordance with one or more embodiments of processing optimization load adjustment. Generally, any of the services, functions, methods, procedures, components, and modules described herein can be implemented using software, firmware, hardware (e.g., fixed logic circuitry), manual processing, or any combination thereof. A software implementation represents program code that performs specified tasks when executed by a computer processor. The example methods may be described in the general context of computer-executable instructions, which can include software, applications, routines, programs, objects, components, data structures, procedures, modules, functions, and the like. The program code can be stored in one or more computer-readable storage media devices, both local and/or remote to a computer processor. The methods may also be practiced in a distributed computing environment by multiple computer devices. Further, the features described herein are platform-independent and can be implemented on a variety of computing platforms having a variety of processors.

FIG. 3 illustrates example method(s) 300 of processing optimization load adjustment. The order in which the method blocks are described are not intended to be construed as a limitation, and any number of the described method blocks can be combined in any order to implement a method, or an alternate method.

At block 302, work units are processed for a software build project that maximizes utilization of processing resources of a computing device. For example, instruction work units 122 of the software build project 118 (FIG. 1) are processed with the processing resources 108 of the computing device 100. The processing resources include the one or more processors 102 (CPUs), the random access memory (RAM) 110, and the disk input/output (I/O) latency threshold 112. Processing resources parameters 116 of the processing resources are definable, and are utilized for comparison to determine whether utilization of the processing resources is optimal.

At block 304, performance data of the processing resources is collected as the work units of the software build project are processed. For example, the processing optimization service 106 collects the performance data in real-time intervals from the performance data counters 114 as the instruction work units 122 of the software build project 118 are processed. Each of the instruction work units 122 may utilize a different amount of CPU, RAM, and/or affect disk I/O latency when the software instructions 120 are processed. The performance data indicates a percentage of CPU utilization, a percentage of available RAM, and disk I/O latency, and the performance data for a processing resource is an average of the performance data when collected in real-time intervals.

At block 306, a determination is made as to whether utilization of the processing resources exceeds optimal processing to process the work units of the software build project while avoiding adverse resource conditions. For example, the processing optimization service 106 determines whether utilization of the processing resources 108 is optimal. Utilization of the processing resources may be adverse to optimal processing, or exceed optimal processing, when low resource conditions are encountered, such as excessive context switches, out of memory, excessive paging, disk thrashing, etc. If utilization of the processing resources does not exceed optimal processing (i.e., “no” from block 306), then at block 308, a determination is made as to whether utilization of the processing resources is optimal. If utilization of the processing resources is optimal (i.e., “yes” from block 308), then the method continues at block 304 to again collect the performance data of the processing resources.

If utilization of the processing resources is not optimal (i.e., “no” from block 308), then at block 310, additional work units of the software build project are scheduled to increase the number of the work units that are processing. For example, the scheduler 124 of the computing device 100 schedules additional instruction work units 122 of the software build project 118 for processing to increase the number of work units that are processing if the processing optimization service 106 determines that utilization of the processing resources 108 is not optimal. When utilization of the processing resources does not exceed optimal processing as determined at block 306, and utilization of the processing resources is not optimal as determined at block 308, then utilization of the processing resources is sub-optimal and the number of work units that are processing for the software build project is increased. The method then continues at block 304 to again collect the performance data of the processing resources.

If utilization of the processing resources does exceed optimal processing (i.e., “yes” from block 306), then at block 312 a determination is made as to whether the current work units that are processing are allowed to complete processing. For example, the processing optimization service 106 determines whether current instruction work units 122 that are processing will be allowed to complete processing. If the current work units are allowed to complete processing (i.e., “yes” from block 312), then the method then continues at block 304 to again collect the performance data of the processing resources. If the current work units are not allowed to complete processing (i.e., “no” from block 312), then at block 314, the number of work units that are processing for the software build project are decreased. For example, the scheduler 124 of computing device 100 decreases the number of instruction work units 122 that are processing. The method then continues at block 304 to again collect the performance data of the processing resources.

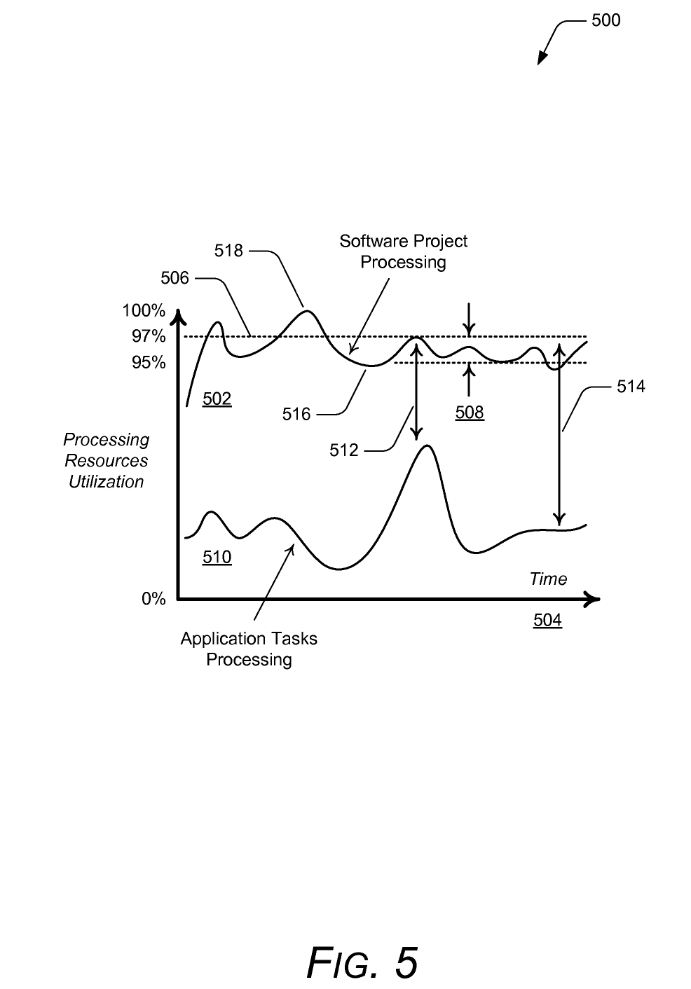

FIG. 4 illustrates another example computing device 400 in which embodiments of processing optimization load adjustment can be implemented. As described with reference to the computing device shown in FIG. 1, the example computing device 400 may be any type of a computer, server, dedicated machine, state machine, and the like. The computing device can be implemented with various components, such as one or more processors 402 (CPUs) and memory devices 404 (e.g., computer-readable storage media) that enable data storage. The computing device may also include any number and combination of differing components as further described with reference to the example device shown in FIG. 7. The processors and memory of the computing device implement a processing optimization service 406 as computer-executable instructions, such as a software application, that is executable to implement the various embodiments of processing optimization load adjustment described herein.

The computing device 400 includes processing resources 408, such as the one or more processors 402 (CPUs), random access memory (RAM) 410, and a disk input/output (I/O) latency threshold 412. Performance data counters 414 maintain performance data of the processing resources as tasks and instructions of software applications and/or build projects are executed. The performance data that corresponds to the processing resources indicates a percentage of CPU utilization, a percentage of available RAM, and disk I/O latency. The computing device 400 also includes processing resources parameters 416, and the parameters of the processing resources 408 are definable for comparison to determine whether utilization of the processing resources is optimal. The processing optimization service 406 is implemented to collect the performance data in real-time intervals from the performance data counters.

The computing device 400 can be utilized to build or execute a software build project 418, such as a large-scale software development build project that maximizes utilization of processing resources 408 of the computing device. The computing device 400 may also include other device applications 420 that are utilized by a user of the device, and that are processing on the device. For example, a developer may initiate a build of the software build project while also accessing an email application, working in a database application, and the like. Although the software build project could take over utilization of the processing resources of the computing device, this would not accommodate the user wanting to also work with the other device applications. In a similar environment, the computing device may build or execute two or more instances of a build project, and shared utilization of the processing resources is needed to accomplish the multiple build projects efficiently.

The RAM 410 loads and maintains software instructions 422 of the software build project and the other device applications. Instruction work units 424 of the software build project and application task instructions 426 are processed with the processing resources. Each of the instruction work units 424 of the software build project may utilize a different amount of CPU, RAM, and/or affect disk I/O latency when the software instructions are processed. Similarly, the application task instructions 426 for the device applications will utilize an unknown quantity of the processing resources, and utilization of the processing resources for the device applications is not controlled or limited. Embodiments of processing optimization load adjustment are implemented for optimal utilization of the processing resources to build or execute the software build project while also avoiding interruption of the application task instructions that are processed for the additional device applications. Generally, the software build project does not “take over” and consume all of the processing resources, but rather utilizes the remaining available processing resources that are not utilized to process the other device applications.

In embodiments, the processing optimization service 406 is implemented to determine whether utilization of the processing resources 408 is optimal to process the software build project 418 (e.g., the instruction work units 424 of the software build project) and the device applications 420 (e.g., the application task instructions 426). Similar to the computing device described with reference to FIG. 1, the example computing device 400 also includes a scheduler 428.

In embodiments, the scheduler 428 may include the processing optimization service 406 as an integrated component or service of the scheduler. Alternatively, the software build project 418 may be implemented to include the processing optimization service as an integrated component or service of the project. The scheduler is implemented to schedule the processing of additional work units of the software build project to increase the number of instruction work units that are processing if the processing optimization service determines that utilization of the processing resources 408 is not optimal. If the processing optimization service determines that utilization of the processing resources exceeds optimal processing, the scheduler is also implemented to either decrease the number of instruction work units that are processing, or allow the current instruction work units to complete processing.

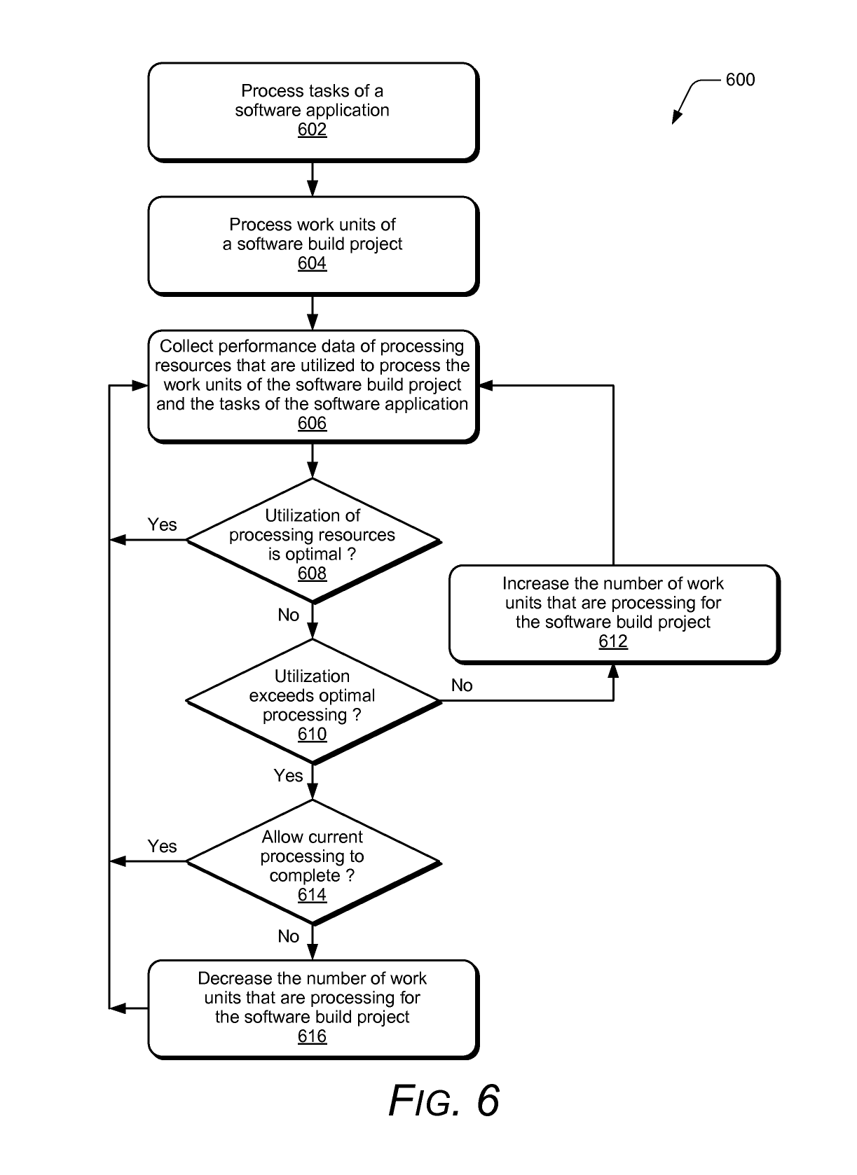

FIG. 5 illustrates another example chart 500 of processing resources utilization 502 over time 504 in accordance with the various embodiments of processing optimization load adjustment described herein. In this example, an optimization 506 of the processing resources 408 in a computing device 400 (FIG. 4) is implemented as approximately 97% utilization of the processing resources. The optimization of the processing resources may also be defined or implemented as a range 508 of utilization, such as from approximately 95% to 97% in this example. Additionally, the additional device applications 420 utilize an unknown quantity of the processing resources over time at 510.

As described above with reference to the computing device 400 shown in FIG. 4, the processing optimization service 406 is implemented to determine whether utilization of the processing resources 408 is optimal to process the software build project 418 (e.g., the instruction work units 424 of the software build project) and the device applications 420 (e.g., the application task instructions 426). Optimal utilization of the processing resources to build or execute the software build project utilizes the remaining available processing resources that are not used to process the application task instructions for the additional device applications. For example, fewer processing resources are available at 512 to process the instruction work units of the software build project than are available at 514. Fewer processing resources are utilized at 514 to process the application task instructions for the additional device applications, and correspondingly, more processing resources are available to process the instruction work units of the software build project.

Optimal utilization of the processing resources is also monitored to avoid adverse resource conditions of the processing resources. For example, when the utilization 502 of the processing resources 408 is less than optimal at 516, the scheduler 428 is implemented to schedule the processing of additional instruction work units of the software build project to increase the number of instruction work units that are processing. Alternatively, when the processing optimization service 406 determines that utilization of the processing resources 408 exceeds optimal processing at 518, the scheduler is implemented to either decrease the number of instruction work units that are processing, or allow the current instruction work units to complete processing.

FIG. 6 illustrates example method(s) 600 of processing optimization load adjustment. The order in which the method blocks are described are not intended to be construed as a limitation, and any number of the described method blocks can be combined in any order to implement a method, or an alternate method.

At block 602, tasks of a software application are processed and, at block 604, work units of a software build project are processed. For example, the application task instructions 426 of the device applications 420 (FIG. 4) and the instruction work units 424 of the software build project 418 are processed with the processing resources 408 of the computing device 400. The processing resources include the one or more processors 402 (CPUs), the random access memory (RAM) 410, and the disk input/output (I/O) latency threshold 412.

At block 606, performance data is collected for processing resources that are utilized to process the work units of the software build project and the tasks of the software application. For example, the processing optimization service 406 collects the performance data in real-time intervals from the performance data counters 414 as the instruction work units 424 of the software build project 418 and the application task instructions 426 of the device applications 420 are processed. Each of the instruction work units 424 may utilize a different amount of CPU, RAM, and/or affect disk I/O latency when the software instructions 422 are processed. The performance data indicates a percentage of CPU utilization, a percentage of available RAM, and disk I/O latency.

At block 608, a determination is made as to whether utilization of the processing resources is optimal for processing the work units of the software build project without interruption to processing the tasks of the software application. For example, the processing optimization service 406 determines whether utilization of the processing resources 408 is optimal without interruption to processing the application task instructions 426 of the device applications 420. Optimal utilization of the processing resources to build or execute the software build project 418 utilizes the remaining available processing resources that are not used to process the application task instructions 426 for the additional device applications.

If utilization of the processing resources is optimal (i.e., “yes” from block 608), then the method continues at block 606 to again collect the performance data for the processing resources. If utilization of the processing resources is not optimal (i.e., “no” from block 608), then at block 610, a determination is made as to whether utilization of the processing resources exceeds optimal processing. For example, the processing optimization service 406 determines whether utilization of the processing resources 408 is optimal. Utilization of the processing resources may be adverse to optimal processing, or exceed optimal processing, when low resource conditions are encountered.

If utilization of the processing resources does not exceed optimal processing (i.e., “no” from block 610), then at block 612, the number of work units that are processing for the software build project is increased. For example, the scheduler 428 of the computing device 400 schedules additional instruction work units 424 of the software build project 418 for processing to increase the number of work units that are processing if the processing optimization service 406 determines that utilization of the processing resources 408 is not optimal. When utilization of the processing resources is not optimal as determined at block 608, and utilization of the processing resources does not exceed optimal processing as determined at block 610, then utilization of the processing resources is sub-optimal and the number of instruction work units that are processing for the software build project is increased.

If utilization of the processing resources does exceed optimal processing (i.e., “yes” from block 610), then at block 614, a determination is made as to whether the current work units that are processing are allowed to complete processing. For example, the processing optimization service 406 determines whether current instruction work units 424 that are processing will be allowed to complete processing. If the current work units are not allowed to complete processing (i.e., “no” from block 614), then at block 616, the number of work units that are processing for the software build project are decreased. For example, the scheduler 428 of computing device 400 decreases the number of instruction work units 424 that are processing. If the current work units are allowed to complete processing (i.e., “yes” from block 614), or continuing from block 616, the method continues at block 606 to again collect the performance data for the processing resources.

FIG. 7 illustrates various components of an example device 700 that can be implemented as any of the devices, or services implemented by devices, described with reference to the previous FIGS. 1-6. In embodiments, the device may be implemented as any one or combination of a fixed or mobile device, in any form of a consumer, computer, server, portable, user, communication, phone, navigation, television, appliance, gaming, media playback, and/or electronic device. The device may also be associated with a user (i.e., a person) and/or an entity that operates the device such that a device describes logical devices that include users, software, firmware, hardware, and/or a combination of devices.

The device 700 includes communication devices 702 that enable wired and/or wireless communication of device data 704, such as received data, data that is being received, data scheduled for broadcast, data packets of the data, etc. The device data or other device content can include configuration settings of the device, media content stored on the device, and/or information associated with a user of the device. Media content stored on the device can include any type of audio, video, and/or image data. The device includes one or more data inputs 706 via which any type of data, media content, and/or inputs can be received, such as user-selectable inputs, messages, communications, music, television content, recorded video content, and any other type of audio, video, and/or image data received from any content and/or data source.

The device 700 also includes communication interfaces 708, such as any one or more of a serial, parallel, network, or wireless interface. The communication interfaces provide a connection and/or communication links between the device and a communication network by which other electronic, computing, and communication devices communicate data with the device.

The device 700 includes one or more processors 710 (e.g., any of microprocessors, controllers, and the like) which process various computer-executable instructions to control the operation of the device. Alternatively or in addition, the device can be implemented with any one or combination of software, hardware, firmware, or fixed logic circuitry that is implemented in connection with processing and control circuits which are generally identified at 712. Although not shown, the device can include a system bus or data transfer system that couples the various components within the device. A system bus can include any one or combination of different bus structures, such as a memory bus or memory controller, a peripheral bus, a universal serial bus, and/or a processor or local bus that utilizes any of a variety of bus architectures.

The device 700 also includes one or more memory devices 714 (e.g., computer-readable storage media) that enable data storage, such as random access memory (RAM), non-volatile memory (e.g., read-only memory (ROM), flash memory, etc.), and a disk storage device. A disk storage device may be implemented as any type of magnetic or optical storage device, such as a hard disk drive, a recordable and/or rewriteable disc, and the like. The device may also include a mass storage media device.

Computer readable media can be any available medium or media that is accessed by a computing device. By way of example, and not limitation, computer readable media may comprise storage media and communication media. Storage media include volatile and non-volatile, removable and non-removable media implemented in any method or technology for storage of information, such as computer-readable instructions, data structures, program modules, or other data. Storage media include, but are not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by a computer.

Communication media typically embody computer-readable instructions, data structures, program modules, or other data in a modulated data signal, such as carrier wave or other transport mechanism. Communication media also include any information delivery media. The term modulated data signal means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

A memory device 714 provides data storage mechanisms to store the device data 704, other types of information and/or data, and various device applications 716. For example, an operating system 718 can be maintained as a software application with a memory device and executed on the processors. The device applications may also include a device manager, such as any form of a control application, software application, signal processing and control module, code that is native to a particular device, a hardware abstraction layer for a particular device, and so on. In this example, the device applications 716 include a scheduler application 720 and a processing optimization service 722, such as when the device 700 is implemented as a computing device. The scheduler application 720 and the processing optimization service 722 are shown as software modules and/or computer applications. Alternatively or in addition, the scheduler application 720 and/or the processing optimization service 722 can be implemented as hardware, software, firmware, fixed logic, or any combination thereof.

The device 700 also includes an audio and/or video processing system 724 that generates audio data for an audio system 726 and/or generates display data for a display system 728. The audio system and/or the display system may include any devices that process, display, and/or otherwise render audio, video, display, and/or image data. Display data and audio signals can be communicated to an audio device and/or to a display device via an RF (radio frequency) link, S-video link, composite video link, component video link, DVI (digital video interface), analog audio connection, or other similar communication link. In implementations, the audio system and/or the display system are external components to the device. Alternatively, the audio system and/or the display system are integrated components of the example device.

Although embodiments of processing optimization load adjustment have been described in language specific to features and/or methods, the subject of the appended claims is not necessarily limited to the specific features or methods described. Rather, the specific features and methods are disclosed as example implementations of processing optimization load adjustment.

1. A computer-implemented method, comprising:
processing work units of a software build project that maximizes utilization of processing resources of a computing device;
collecting performance data of the processing resources as one or more of the work units of the software build project are processed;
determining whether the utilization of the processing resources is optimal to process the software build project while avoiding adverse resource conditions; and
increasing a number of the work units that are processing in response to said determining that utilization of the processing resources is not optimal.

2. A computer-implemented method as recited in claim 1, further comprising, in response to said determining that utilization of the processing resources exceeds optimal processing, one of:
decreasing the number of the work units that are processing; or
allowing the work units that are processing to complete processing.

3. A computer-implemented method as recited in claim 1, further comprising scheduling additional work units of the software build project to increase the number of the work units that are processing.

4. A computer-implemented method as recited in claim 1, wherein parameters of the processing resources are definable as a basis for said determining whether the utilization of the processing resources is optimal.

5. A computer-implemented method as recited in claim 1, wherein:
the processing resources of the computing device comprise one or more processors (CPU), random access memory (RAM), and a disk input/output (disk I/O) latency threshold; and
the performance data indicates a percentage of CPU utilization, a percentage of available RAM, and disk I/O latency.

6. A computer-implemented method as recited in claim 1, wherein each work unit of the software build project invokes different levels of processing resources utilization.

7. A computer-implemented method as recited in claim 1, wherein the performance data for a processing resource is an average of the performance data and collected in real-time intervals.

8. A computer-implemented method as recited in claim 1, further comprising processing tasks for one or more additional applications that are executing on the computing device;
wherein the performance data indicates utilization of the processing resources to process the tasks for the one or more additional applications and the one or more work units of the software build project; and
wherein said determining whether the utilization of the processing resources is optimal to process the software build project includes avoiding interrupting the processing of the tasks for the one or more additional applications.

9. A computing device, comprising:
one or more processors (CPU) configured to execute software instructions;
random access memory (RAM) configured to maintain the software instructions to process work units of a software build project that maximizes utilization of processing resources of the computing device;
performance data counters that maintain performance data of the processing resources as one or more of the work units of the software build project are processed;
a processing optimization service configured to determine whether the utilization of the processing resources is optimal to process the software build project and avoid adverse resource conditions; and
a scheduler configured to schedule additional work units of the software build project to increase a number of the work units for processing in response to a determination that utilization of the processing resources is not optimal.

10. A computing device as recited in claim 9, wherein, in response to a determination that utilization of the processing resources exceeds optimal processing, the scheduler is further configured to:
decrease the number of the work units for processing; or
allow the work units that are processing to complete processing.

11. A computing device as recited in claim 9, wherein at least one of:
the scheduler includes the processing optimization service; or
the software build project includes the processing optimization service.

12. A computing device as recited in claim 9, wherein:
the processing resources of the computing device includes the one or more CPUs, the RAM, and a disk input/output (disk I/O) latency threshold; and
the performance data indicates a percentage of CPU utilization, a percentage of available RAM, and disk I/O latency.

13. A computing device as recited in claim 9, wherein the processing optimization service is further configured to collect the performance data in real-time intervals from the performance data counters.

14. A computing device as recited in claim 9, wherein parameters of the processing resources are definable as a basis for said determining whether the utilization of the processing resources is optimal.

15. A computing device as recited in claim 9, wherein:
the one or more processors are further configured to execute the software instructions for tasks of one or more additional applications that are executed by the computing device; and
wherein the performance data indicates utilization of the processing resources to process the tasks for the one or more additional applications and the one or more work units of the software build project.

16. A computing device as recited in claim 15, wherein the processing optimization service is further configured to determine whether the utilization of the processing resources is optimal to process the software build project includes to avoid an interruption of the tasks that are processed for the one or more additional applications.

17. A computer-implemented method, comprising:
processing tasks of a software application;
processing work units of a software build project;
collecting performance data of processing resources that are utilized for said processing the work units of the software build project and for said processing the tasks of the software application; and
determining whether utilization of the processing resources is optimal for said processing the work units of the software build project without interruption to said processing the tasks of the software application.

18. The computer-implemented method as recited in claim 17, further comprising increasing a number of the work units that are processing for the software build project if utilization of the processing resources is not optimal.

19. The computer-implemented method as recited in claim 17, further comprising decreasing a number of the work units that are processing for the software build project if utilization of the processing resources exceeds optimal processing.

20. The computer-implemented method as recited in claim 17, wherein:
the processing resources comprise one or more processors (CPU), random access memory (RAM), and a disk input/output (disk I/O) latency threshold;
the performance data indicates a percentage of CPU utilization, a percentage of available RAM, and disk I/O latency; and
each work unit of the software build project invokes different levels of processing resources utilization.
